(19) United States
(12) Patent Application Publication
(10) Pub. No.: US 2004/0218960 A1
(43) Pub. Date: Nov. 4, 2004

(54) Method and apparatus for printer head error compensation

(75) Inventor: Frederick Lin, Fremont, CA (US)

Correspondence Address: NIKOLAI & MERSEREAU, P.A., 900 SECOND AVENUE SOUTH, SUITE 820, MINNEAPOLIS, MN, 55402, US

(73) Assignee: Pictologic, Inc., Fremont, CA

(21) Appl. No.: 10/827,508

(22) Filed: Apr. 19, 2004

Related U.S. Application Data
(60) Provisional application No. 60/466,681, filed on Apr. 29, 2003.

(51) Int. Cl. G03G 13/04

(52) U.S. Cl. 400/118.2

(57) ABSTRACT

An LED printing system includes a data source, a printer controller and an LED printer head. The data source is used to provide original data. The printer controller is used to process the original data. The LED printer head is used to print the processed data without further processing them.

### CROSS REFERENCE

The present application claims the benefit of U.S. Provisional Application No. 60/466,681 filed Apr. 29, 2003.

### FIELD OF INVENTION

The present invention relates to a method and apparatus for printer head error compensation.

### BACKGROUND OF INVENTION

Referring to FIG. 7, a typical printing system includes a data source S such as a computer or scanner, a printer controller C for receiving data from the data source S and a printer head H for printing under control of the printer controller C. The printer head H is a laser printer head H′ shown in FIG. 8 or an increasingly popular light-emitting diode (“LED”) printer head H″ shown in FIGS. 9˜12.

Referring to FIG. 8, the laser printer head H′ includes a laser source 62 for emitting laser beams, a rotating mirror 64 for reflecting the laser beams, a lens 66 for refracting the laser beams and a drum 68 for taking the laser beams. Static charges are accumulated on spots on which the laser beams are cast. The laser printer head H′ will not be described in detail for being conventional.

Referring to FIG. 9, the LED printer head H″ includes an LED array and driver assembly 70 for producing light beams, an SFL (“self-focusing lens”) 72 for focusing the light beams and a photosensitive drum 74 for taking the light beams. A print image will be formed based on spots of the photosensitive drum 74 that take the LED light beams.

Referring to FIGS. 11 and 12, the LED array and driver assembly 70 includes a substrate 76, an LED array A installed on the substrate 76 for providing the light beams and a driver D installed on the substrate 76 and connected with the LED array A by means of an interconnection 78. The LED array A is driven by means of the driver D. The driver D is usually made via a high-density CMOS semiconductor process.

The LED printer head H″ takes up less physical space than the laser printer head H′, thus rendering possible a more compact printer. However, the LED printer head H″ faces some design challenges. The most critical is uniformity control of the light-emitting diodes. It is intended that all of the light-emitting diodes provide brightness at a nominal value. Because of variation and inaccuracy during fabrication, the light-emitting diodes however differ from one another regarding brightness. For each LED, the actual brightness can be up to 20% more or less than the nominal value, i.e., the error in brightness can be as much as 20%. That is, one LED may differ from another in brightness as much as 40% of the nominal value.

Referring to FIG. 12, it has been a standard practice to include built-in compensation logic in the LED printer head H″. To this end, the LED printer head H″ includes a calibration data memory 80 and a dot on/off controller 82. The calibration data memory 80 is used for receiving calibration data about the errors in brightness and later sending the calibration data to the driver D. The calibration data memory is usually implemented as part of the driver chip. More precisely, there are two memories—a permanent storage such as a flash memory and an EEROM for storing the calibration data and a static or dynamic RAM for storing the calibration data before the calibration data are sent to an exposure control circuit. With the input of the calibration data for each dot, the driver D can compensate the error in brightness of each LED element via controlling either the electric current intensity or the time duration that each LED element is turned on. However, it is an expensive practice to include the calibration data memory 80 in the LED printer head H″.

The present invention is therefore intended to obviate or at least alleviate the problems encountered in prior art.

### SUMMARY OF INVENTION

It is an objective of the present invention to provide an LED printer head with a cost-effective apparatus for error compensation.

According to the present invention, an LED printing system includes a data source, a printer controller and an LED printer head. The data source is used to provide original data. The printer controller is used to provide processed data by means of processing the original data. The LED printer head is used to print the processed data without further processing them.

Other objects, advantages and novel features of the invention will become more apparent from the following detailed description in conjunction with the attached drawings.

### BRIEF DESCRIPTION OF DRAWINGS

The present invention will be described via detailed illustration of embodiments referring to the drawings.

FIG. 1 is a block diagram of a printing system for compensating printer head error according to the present invention.

FIG. 2 is a block diagram of a printing system according to a first embodiment of the present invention.

FIG. 3 is a block diagram of a printing system according to a second embodiment of the present invention.

FIG. 4 is a block diagram of a printing system according to a third embodiment of the present invention.

FIG. 5 is a block diagram of a printing system according to a fourth embodiment of the present invention.

FIG. 6 is a block diagram of a printing system according to a fifth embodiment of the present invention.

FIG. 7 is a block diagram of a printing system according to prior art.

FIG. 8 is a simplified perspective view of a laser printer head.

FIG. 9 is a simplified perspective view of an LED printer head.

FIG. 10 is a side view of the LED printer head of FIG. 9.

FIG. 11 is a simplified perspective view of an LED array and driver assembly for use in the LED printer of FIG. 9.

FIG. 12 is a block diagram of the LED printer head of FIG. 9.

### DETAILED DESCRIPTION OF EMBODIMENTS

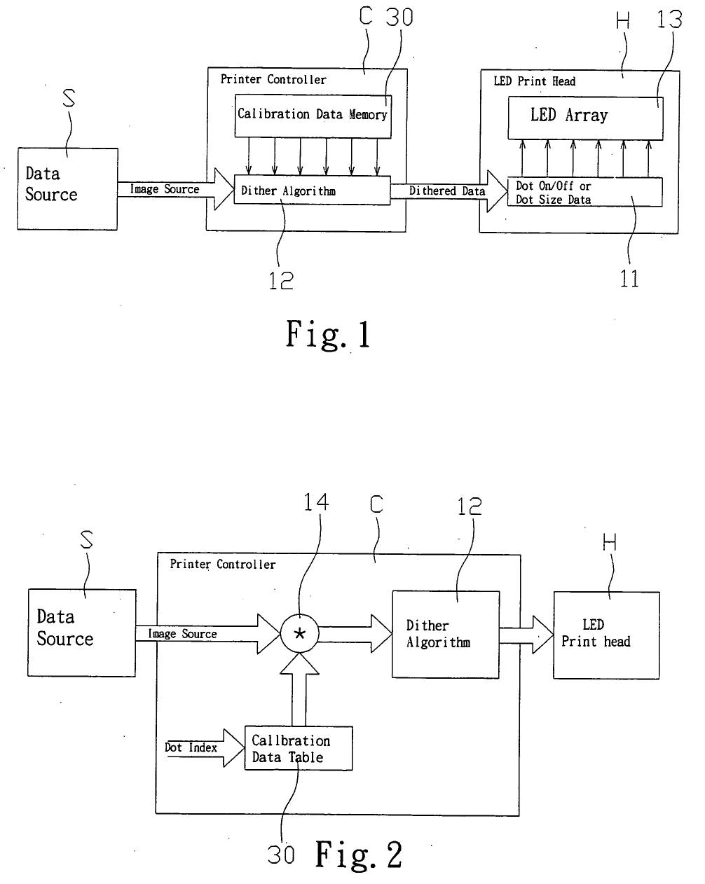

FIG. 1 shows a printing system 10 in which a method for printer head error compensation according to the present invention is performed. The printing system 10 includes a data source S such as a computer or scanner, a printer controller C for receiving data from the data source S and an LED printer head H for printing under control of the printer controller C.

The LED printer head H includes a dot controller 11 for receiving the processed data from the printer controller C and an LED array 13 for printing under control of the dot controller 11. In a one-bit-per-pixel printing system, the dot controller 11 controls the on/off of each dot related to every LED of the LED array 13. In a multi-bit-per-pixel printing system, the dot controller 11 controls not only the on/off of every dot but also the size of every dot that is turned on via current or exposure time control. Not like any conventional LED printer head, the LED printer head H does not include a memory for storing calibration data.

FIG. 2 shows a printing system according to a first embodiment of the present invention. The printer controller C includes a dither block 12, a multiplier 14 connected with the dither block 12 and a calibration data memory 30 connected with the multiplier 14. Calibration data of the LED printer head H are stored in the calibration data memory 30. In the multiplier 14, multiplication is performed. In the dither block 12, a dither algorithm is performed. The calibration data memory 30 and the dither block 12 will not be described in detail for being conventional.

In operation, source data are provided to the multiplier 14 from the data source S. The calibration data are sent to the multiplier 14 from the calibration data memory 30. In the multiplier 14, the source datum of each dot is multiplied by the calibration datum of said dot. The multiplied data are sent to dither block 12 from the multiplier 14. In the dither block 12, the multiplier data are dithered. The dithered data are sent to the LED printer head H from the dither block 12.

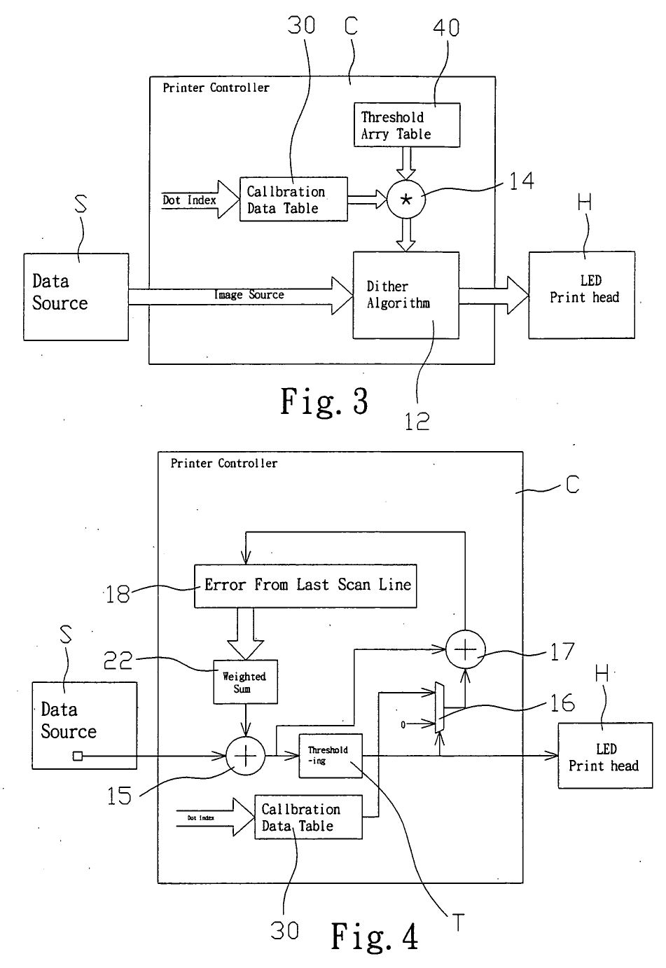

FIG. 3 shows a printing system according to a second embodiment of the present invention conducting a dither algorithm based on a threshold array. The printer controller C includes a dither block 12, a multiplier 14 connected with the dither block 12, a calibration data memory 30 connected with the multiplier 14 and a threshold memory 40 connected with the multiplier 14. The printer controller C of the second embodiment is identical to the printer controller C of the first embodiment except for including the threshold memory 40 for storing the threshold array. The threshold memory 40 will not be described in detail for being conventional.

In operation, the source data are sent to the dither block 12 from the data source S. The calibration data are sent to the multiplier 14 from the calibration data memory 30. The threshold array is sent to the multiplier 14 from the threshold memory 40. In the multiplier 14, all of the thresholds in the threshold array are multiplied by the calibration data, i.e., the threshold array is modified. In the dither block 12, the source data are compared with the modified threshold array and dithered. The dithered data are sent to the LED printer head H from the dither block 12.

As discussed above, the error in brightness of each LED of the LED printer head H is compensated by means of the method and apparatus according to the present invention without having to send the calibration data from the printer controller C to the LED printer head H.

FIG. 4 shows a printing system according to a third embodiment of the present invention performing a dither algorithm based on an error diffusion method.

The error diffusion will be briefly described through an example where a page is processed line by line from top to bottom and a line is processed dot by dot from left to right.

In processing the first dot of the first line, its source value is shifted by an error so as to render a resultant value. The resultant value of the first dot of the first line is used to drive an LED. The error of the first dot of the first line is divided and passed to the second dot of the first line and the first and second dots of the second line. In processing the second dot of the first line, its source value and the error from the first dot of the first line are summed up and then shifted by an error so as to render a resultant value. The resultant value of the second dot of the first line is used to drive an LED. The error of the second dot of the first line is divided and passed to the third dot of the first line and the first, second and third dots of the second line. So are the rest dots of the first line except for the last dot of the first line that does not have any dot to its right and lower right.

In processing the first dot of the second line, its source value and the errors from the first and second dots of the first line are summed up and then shifted by an error so as to render a resultant value. The resultant value of the first dot of the second line is used to drive an LED. The error of the first dot of the second line is divided and passed to the second dot of the second line and the first and second dots of the third line. In processing the second dot of the second line, its source value, the errors from the first, second and third dots of the first line and the error from the first dot of the second line are summed up and then shifted by an error so as to render a resultant value. The resultant value of the second dot of the second line is used to drive an LED. The error of the second dot of the second line is divided and passed to the third dot of the second line and the first, second and third dots of the third line. So are the rest dots of the second line except for the last dot of the second line that does not have any dot to its right and lower right.

The remaining lines of the page are processed in an identical manner except for the last line that does not have any line below it.

The error diffusion may be implemented in various other processes and will not be further described in detail for being conventional. It should however be noted that the method and apparatus of according to the third embodiment of the present invention can be performed together with any error diffusion process.

Referring to FIG. 4, the printer controller C includes a first adder 15, a threshold block T connected with the first adder 15, a second adder 17 connected with the first adder 15, a multiplexer 16 connected with the second adder 17, a calibration data memory 30 connected with the multiplexer 16, an error memory 18 connected with the second adder 17 and a calculation block 22 connected with the error memory 18 on one hand and connected with the first adder 15 on the other hand.

In operation, an original datum (“ORIGINAL_DATUM”) of a dot (“current dot”) is sent to the first adder 15 from the data source S.

Errors of related previous dots are sent to the calculation block 22 from the error memory 18. For example, the related previous dots are the upper left, upper, upper right and left dots. The error of each related previous dot is multiplied with a specific coefficient so as to render a weighted error. The weighted errors are added up so as to render a weighted error sum (“WES”). WES is sent to the first adder 15 from the calculation block 22.

In the first adder 15, ORIGINAL_DATUM and WES are added up so as to render a sum (“SUM”).

SUM is sent to the threshold block T from the first adder 15. SUM is compared with a threshold (“THRESHOLD”). An output (“OUTPUT”) is set to be 1 if SUM is greater than THRESHOLD and 0 if otherwise. OUTPUT is sent to the LED printer head H. An LED (“current LED”) corresponding to the current dot is turned on or kept off based on OUTPUT.

SUM is sent to the second adder 17 from the first adder 15. In the second adder 17, an error of the current dot (“ERROR”) is calculated. If SUM is greater than THRESHOLD, the current LED is turned on and an error (“LED_ERROR”) related to the current LED occurs. In this case, ERROR is set to be SUM minus OUTPUT minus a function of LED_ERROR. If SUM is not greater than THRESHOLD, the current LED is kept off and LED_ERROR does not occur. In this case, ERROR is set to be SUM.

ERROR is sent to the error memory 18 from the second adder 17.

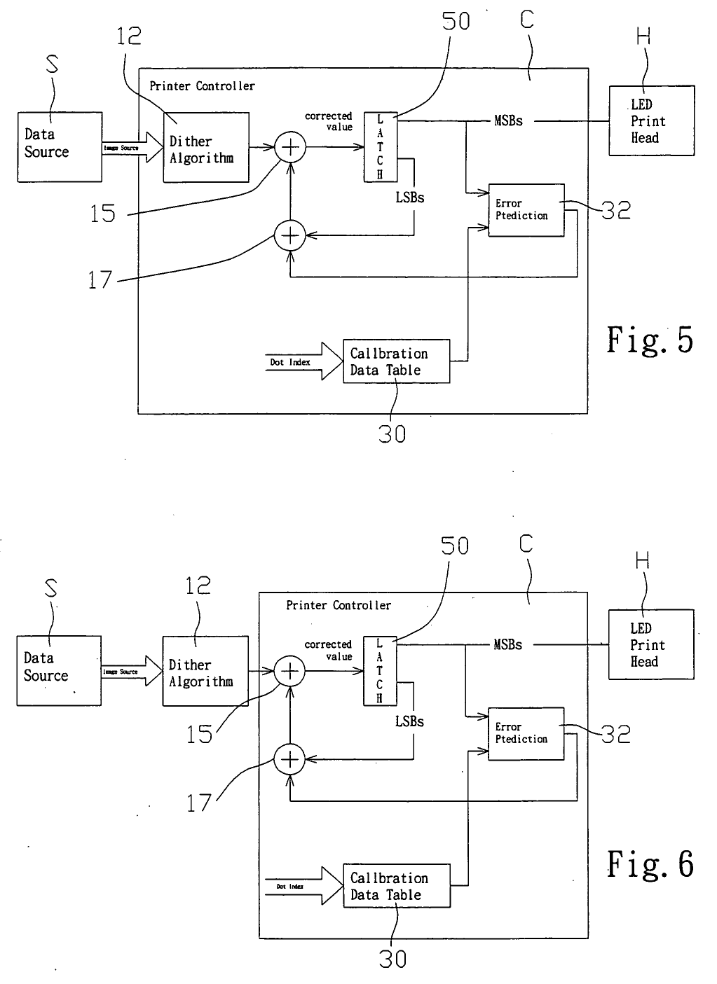

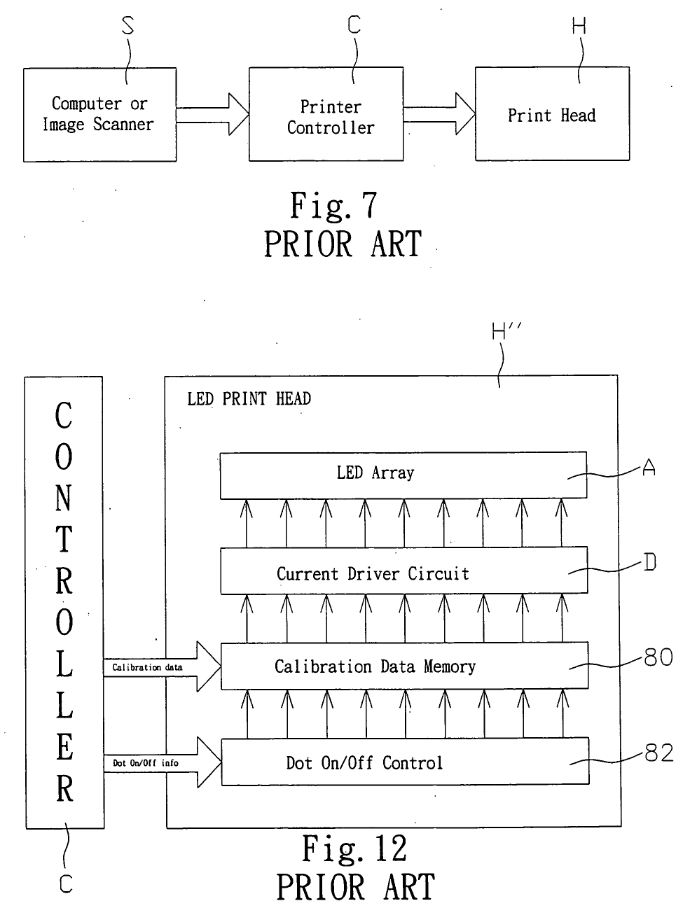

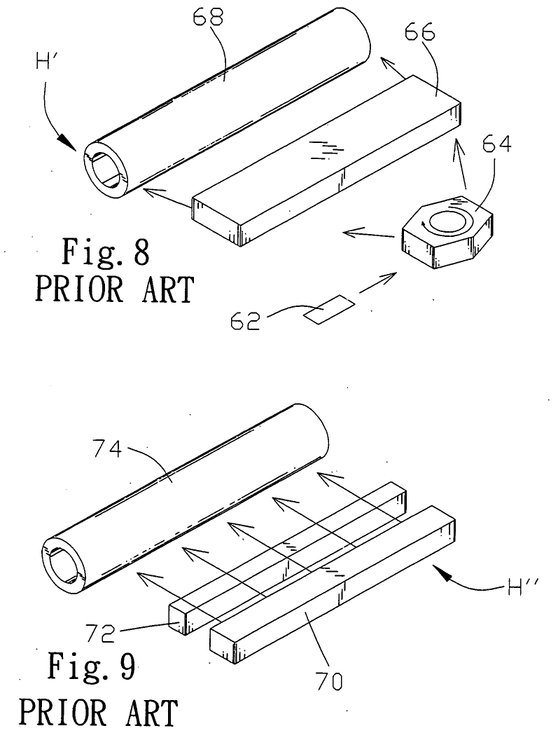

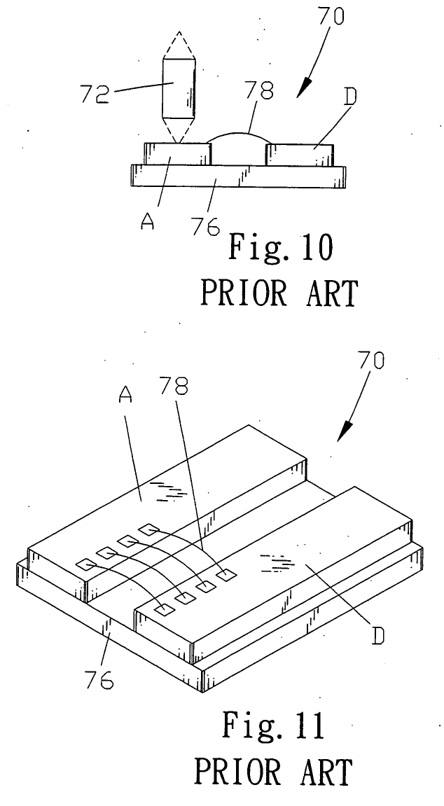

FIG. 5 shows a printing system according to a fourth embodiment of the present invention using the calibration data to modify dithered data. The printer controller C includes a dither block 12, a first adder 15 connected with the dither block 12, a latch 50 connected with the first adder 15, a second adder 17 connected with the latch 50 on one hand and the first adder 15 on the other hand, an error prediction block 32 connected with the latch 50 and a calibration data memory 30 connected with the error prediction block 32.

In operation, source data are sent to the dither block 12 from the data source S. In the dither block 12, the source data are dithered. The dithered data are sent to the first adder 15. In the first adder 15, the dithered datum of a dot (“current dot”) and a sum of errors from previous dots are added up so as to render a corrected value of the current dot. The corrected value is sent to the latch 50 from the first adder 15. In the latch 50, the corrected value is divided into a portion consisting of high order bits or most significant bits (“MSB”) and a portion consisting of low order bits or least significant bits (“LSB”).

MSB represents the integer of the corrected value that will be realized by means of an LED (“current LED”). MSB is sent to the LED printer head H. The current LED is turned on or kept off based on MSB. The error of the current LED thus occurs and must be compensated in some of the following dots. To this end, MSB is sent to the error prediction block 32 from the latch 50. The calibration value of the current LED is sent to the error prediction block 32 from the calibration data memory 30. In the error prediction block 32, an error (“MSB_ERROR”) is estimated by means of a formula or lookup table based on MSB and the calibration value of the current LED. Alternatively, the calibration value of a neighboring LED may also be taken into consideration in the estimation of MSB_ERROR. MSB_ERROR is sent to the second adder 17 from the error prediction block 32.

LSB represents the fractional or leftover portion of the corrected value that is not realized by means of the current LED. Hence, LSB is taken as an error (“LSB_ERROR”) and should be compensated in processing some of the following dots. LSB_ERROR is sent to the second adder 17 from the latch 50.

In the second adder 17, MSB_ERROR and LSB_ERROR are added up so as to render a sum of errors. The sum of errors is sent from the second adder 17 to the first adder 15 for processing the next dot.

FIG. 6 shows a printing system according to a fifth embodiment of the present invention. The fifth embodiment is identical to the fourth embodiment except for installing the dither block 12 outside the printer controller C.

The present invention has been described via detailed illustration of some embodiments. Those skilled in the art can derive variations from the embodiments without departing from the scope of the present invention. Therefore, the embodiments shall not limit the scope of the present invention defined in the claims.

1. An LED printing system including:
a data source (S) for providing original data;
a printer controller (C) for processing the original data; and
an LED printer head (H) for printing the processed data without further processing them.

2. The LED printing system of claim 1 wherein the printer controller (C) includes a calibration data memory (30) for storing calibration data of the LED printer head (H) and a dither block (12) for dithering the original data based on the calibration data.

3. The LED printing system of claim 2 wherein the printer controller (C) includes a multiplier (14) for multiplying the original data with the calibration data before sending them to the dither block (12).

4. The LED printing system of claim 2 wherein the printer controller (C) includes a threshold memory (40) for storing thresholds and a multiplier (14) for multiplying the thresholds with the calibration data before sending them to the dither block (12).

5. The LED printing system of claim 1 wherein the printer controller (C) includes:
a first adder (15) connected with the data source (S);
a threshold block (T) connected with the first adder (15);
a second adder (17) connected with the first adder (15);
a multiplexer (16) connected with the second adder (17);
a calibration data memory (30) connected with the multiplexer (16);
an error memory (18) connected with the second adder (17); and
a calculation block (22) connected with the error memory (18) on one hand and connected with the first adder (15) on the other hand;
wherein an original datum of a current dot is sent from the data source (S) to the first adder (15), and errors of related previous dots are sent from the error memory (18) to the calculation block (22) in which a weighted error sum is calculated based on the errors, and the weighted error sum is sent to the first adder (15) in which the original datum and the weighted error sum are added up so as to render a sum, and the sum is sent to the threshold block (T) in which the sum is compared with a threshold, and an output is set to be a first value if the sum is greater than threshold and a second value if otherwise, and the output is sent to the LED printer head (H) in order to control the on/off of a current LED corresponding to the current dot, and the sum is sent to the second adder (17) in which an error of the current dot is calculated, and the error of the current dot is set to be the sum minus the output minus a function of the error of the current LED if the sum is greater than the threshold and the sum minus the output if otherwise, and the error of the current dot is sent to the error memory (18).

6. The LED printing system of claim 5 wherein the related previous dots are the upper left, upper, upper right and left dots.

7. The LED printing system of claim 5 wherein the weighted error sum is provided via multiplying the error of each previous dot with a specific coefficient so as to render a weighted error and adding up the weighted errors.

8. The LED printing system of claim 5 wherein the first value of the output is 1, and the second value of the output is 0.

9. The LED printing system of claim 1 wherein the printer controller (C) includes:
a dither block (12) connected with the data source (S);
a first adder (15) connected with the dither block (12);
a latch (50) connected with the first adder (15);
a second adder (17) connected with the latch (50) on one hand and the first adder (15) on the other hand;
an error prediction block (32) connected with the latch (50); and
a calibration data memory (30) connected with the error prediction block (32);
wherein source data are sent from the data source (S) to the dither block (12) in which the source data are dithered, and the dithered data are sent to the first adder (15) in which the dithered datum of a current dot and a sum of errors from previous dots are added up so as to render a corrected value of the current dot, and the corrected value is sent to the latch (50) in which the corrected value is divided into a first portion and a second portion, and the first portion of the corrected value is sent to the LED printer head (H) in order to control the on/off of the current LED, and the first portion of the corrected value is sent to the error prediction block (32), and the calibration value of the current LED is sent from the calibration data memory (30) to the error prediction block (32) in which a first error is estimated based on the first portion of the corrected value and the calibration value, and the second portion of the corrected value is taken as a second error and sent to the second adder (17) in which the first and second errors are added up so as to render a sum of errors, and the sum of errors is sent to the first adder (15) for processing a next dot.

10. The LED printing system of claim 9 wherein the first portion of the corrected value includes most significant bits (“MSB”).

11. The LED printing system of claim 10 wherein MSB represents the integer of the corrected value that will be realized by means of the current LED.

12. The LED printing system of claim 9 wherein the first error is estimated by means of a formula.

13. The LED printing system of claim 9 wherein the first error is estimated by means of a lookup table.

14. The LED printing system of claim 9 wherein the calibration value of a neighboring LED is also be taken into consideration in the estimation of the first error.

15. The LED printing system of claim 1 including a dither block (12) between the data source (S) and the printer controller (C).

16. The LED printing system of claim 15 wherein the printer controller (C) includes:
a first adder (15) connected with the dither block (12);
a latch (50) connected with the first adder (15);
a second adder (17) connected with the latch (50) on one hand and the first adder (15) on the other hand;
an error prediction block (32) connected with the latch (50); and
a calibration data memory (30) connected with the error prediction block (32);
wherein source data are sent from the data source (S) to the dither block (12) in which the source data are dithered, and the dithered data are sent to the first adder (15) in which the dithered datum of a current dot and a sum of errors from previous dots are added up so as to render a corrected value of the current dot, and the corrected value is sent to the latch (50) in which the corrected value is divided into a first portion and a second portion, and the first portion of the corrected value is sent to the LED printer head (H) in order to control the on/off of the current LED, and the first portion of the corrected value is sent to the error prediction block (32), and the calibration value of the current LED is sent from the calibration data memory (30) to the error prediction block (32) in which a first error is estimated based on the first portion of the corrected value and the calibration value, and the second portion of the corrected value is taken as a second error and sent to the second adder (17) in which the first and second errors are added up so as to render a sum of errors, and the sum of errors is sent to the first adder (15) for processing a next dot.

17. The LED printing system of claim 16 wherein the first portion of the corrected value includes most significant bits (“MSB”).

18. The LED printing system of claim 16 wherein MSB represents the integer of the corrected value that will be realized by means of the current LED.

19. The LED printing system of claim 16 wherein the first error is estimated by means of a formula.

20. The LED printing system of claim 6 16 wherein the first error is estimated by means of a lookup table.

21. The LED printing system of claim 16 wherein the calibration value of a neighboring LED is also be taken into consideration in the estimation of the first error.

22. The LED printing system of claim 1 wherein the data source (S) is a computer.

23. The LED printing system of claim 1 wherein the data source (S) is a scanner.

24. The LED printing system of claim 1 wherein the LED printer head (H) includes a dot controller (11) for receiving the processed data from the printer controller (C) and an LED array (13) for printing under control of the dot controller (11).

25. The LED printing system of claim 24 wherein the dot controller (11) controls the on/off of each dot corresponding to every LED of the LED array (13).

26. The LED printing system of claim 25 wherein the dot controller (11) controls the size of every LED that is turned on.
